(19) United States
(12) Patent Application Publication
(10) Pub. No.: US 2015/0219940 A1
(43) Pub. Date: Aug. 6, 2015

(54) CURVED BACKLIGHT ASSEMBLY AND CURVED DISPLAY DEVICE HAVING THE SAME

(71) Applicant: Samsung Display Co., LTD., Yongin-City (KR)

(72) Inventors: Jeong-Ki KIM, Daejeon (KR); Young-Dae SONG, Busan (KR)

(21) Appl. No.: 14/326,606

(22) Filed: Jul. 9, 2014

(30) Foreign Application Priority Data
Feb. 4, 2014 (KR) 10-2014-0012383

(51) Int. Cl. G02F 1/1335; F21V 23/00; F21V 8/00

(52) U.S. Cl. CPC G02F 1/1336; G02B 6/0061; F21V 23/005; F21Y 2101/02

(57) ABSTRACT

A curved backlight assembly includes a curved light guide plate (“LGP”), at least one light-emitting diode (“LED”), a printed circuit board (“PCB”) and a curved LED cover. The LGP includes a first side and a second side. The LED generates lights. The PCB has the LED mounted thereon to be disposed adjacent to the first side of the curved LGP. The curved LED cover receives the PCB to be bent along the first side of the curved LGP. Therefore, a generation of a hot-spot phenomenon may be prevented, so that it may emit uniform lights.

This application claims priority to Korean Patent Application No. 10-2014-0012383, filed on Feb. 4, 2014, and all the benefits accruing therefrom under 35 U.S.C. §119, the contents of which are herein incorporated by reference in their entirety.

### BACKGROUND

(1) Field

Exemplary embodiments of the invention relate to a curved backlight assembly and a curved display device having the curved backlight assembly. More particularly, exemplary embodiments of the invention relate to a curved backlight assembly for emitting light uniformly and a curved display device having the curved backlight assembly.

(2) Description of the Related Art

As thin panel display devices such as liquid crystal display (“LCD”) devices have come to be more commonly used as display devices of television receivers, home movie theaters, computers (e.g., those used for high definition gaming) and so on, the screens of flat panel versions of such thin panel display devices (e.g., LCD devices) are tending to become increasingly bigger. But one problem with increasingly larger and flat panel LCD or other such thin profile screens is that the viewing angle differences between the state where the viewer is focusing on the center portion of the screen (normal to the screen surface and the viewer's line of sight (“LOS”) are basically coincident) and where the viewer is focusing on the left and/or right far edges of the flat screen (the normal to the screen surface and the viewer's LOS are substantially not coincident) increases.

Another problem with large-scale flat panel television screens and the like is that glare off the screens from ambient light sources (e.g., room lamps) also tends to increase with increase of flat panel screen size. The problems of difference in viewing angles and excessive glare can be corrected by curving the screen into a concave shape.

### SUMMARY

Even when viewing angle difference is improved (reduced) by a liquid-crystal panel with a concavely curved screen (referred to as “concavely curved liquid-crystal panel” below), the traditional approach is to use a flat panel backlighting unit with a same structure as that used for the conventional flat liquid-crystal panel. When this is done, there is a new problem, namely, that the uniformity of the light intensity that is emitted from the light source inside the flat panel backlighting unit is lost in particular at the peripheral edges of the concavely curved liquid-crystal panel. As a result, the image quality (e.g., brightness) of the concavely curved liquid-crystal panel at the left and right edges becomes lower than that of the screen of a conventional flat panel liquid-crystal display device.

When an edge type backlight assembly is adapted to a curved display device, a misalignment between a curved light guide panel (“LGP”) and a light-emitting diode (“LED”) is generated so that a hot-spot phenomenon may be generated. Here, “hot-spot phenomenon” refers to a non-uniform illumination phenomenon caused when an area near to a light-emitting portion of the LED or an area between the LED adjacent to each other is brighter or darker than a peripheral area.

One or more exemplary embodiment of the invention provides a backlight assembly for emitting light uniformly by preventing a generation of a hot-spot phenomenon due to a misalignment between a curved light guide plate and a light-emitting diode.

One or more exemplary embodiment of the invention also provides a curved display device having the curved backlight assembly.

According to an exemplary embodiment, a curved backlight assembly includes a curved light guide plate (“LGP”), a light source such as a light-emitting diode (“LED”), a printed circuit board (“PCB”) and a curved LED cover. The LGP includes a first side and a second side. The LED generates light. The PCB has the LED mounted thereon and is adjacent to the first side of the curved LGP. The curved LED cover receives the PCB and is curved along the first side of the curved LGP.

In an exemplary embodiment, the curved LED cover may be coupled to a portion of the curved LGP.

In an exemplary embodiment, the curved LED cover may have a planar plate structure.

In an exemplary embodiment, an opening portion may be defined in the curved LED cover.

In an exemplary embodiment, the opening portion may be defined at an area corresponding to the LED.

In an exemplary embodiment, the opening portion may be provided in plural and the opening portions may be arranged in a zigzag type.

In an exemplary embodiment, the curved LED cover and the light source may be provided in plural. The curved LED covers may be spaced apart from each other and each coupled to a portion of the curved LGP.

In an exemplary embodiment, the curved LED covers may respectively cover the LEDs.

In an exemplary embodiment, the PCB may be curved along the first side of the LGP.

In an exemplary embodiment, a length of the first side and a length of the second side may be different from each other.

In an exemplary embodiment, the curved backlight assembly may further include a bottom chassis which receives the curved LGP, the PCB and the curved LED cover. The bottom chassis may be curved along a curvature of the curved LED cover.

According to an exemplary embodiment of the invention, a curved display device includes a display panel assembly, and a curved backlight assembly on a rear surface of the display panel assembly and configured to provide the display panel assembly with light. The curved backlight assembly includes a curved LGP, a light source such as an LED, a PCB and a curved LED cover. The LGP includes a first side and a second side. The LED generates the light. The PCB has the LED mounted thereon and is adjacent to the first side of the curved LGP. The curved LED cover receives the PCB and is curved along the first side of the curved LGP.

In an exemplary embodiment, the curved LED cover may be coupled to a portion of the curved LGP. The curved LED cover may have a planar plate structure.

In an exemplary embodiment, the curved LED cover may be coupled to a portion of the curved LGP. An opening portion may be defined in the curved LED cover.

In an exemplary embodiment, the curved LED cover may be coupled to a portion of the curved LGP. Here, the curved LED cover may be provided in plural. The curved LED covers may be spaced apart from each other to each be coupled to the portion of the curved LGP.

According to one or more exemplary embodiment of the invention, a curved LED cover which is coupled to a portion of a LGP curved so as to adapt to a curved display panel is disposed on the curved display panel, so that a misalignment between the curved LGP and the LEDs disposed adjacent thereto may be removed. Therefore, a generation of a hot-spot phenomenon may be reduced or effectively prevented, so that the curved backlight assembly may emit uniform light to the curved display panel.

### BRIEF DESCRIPTION OF THE DRAWINGS

The above and other features of the invention will become more apparent by describing in detailed exemplary embodiments thereof with reference to the accompanying drawings, in which:

FIG. 1 is a perspective view schematically showing an exemplary embodiment of a curved display device according to the invention;

FIG. 2 is an exploded perspective view schematically showing the curved display device shown in FIG. 1;

FIG. 3 is a cross-sectional view of a portion of the curved display device shown in FIG. 2;

FIG. 4 is an exploded perspective view schematically showing another exemplary embodiment of a curved display device according to the invention;

FIG. 5 is an exploded perspective view schematically showing still another exemplary embodiment of a curved display device according to the invention;

FIG. 6 is a perspective view schematically showing yet another exemplary embodiment of a curved display device according to the invention; and

FIG. 7 is an exploded perspective view schematically showing the curved display device shown in FIG. 6.

### DETAILED DESCRIPTION OF THE INVENTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, the element or layer can be directly on, connected or coupled to another element or layer or intervening elements or layers. In contrast, when an element is referred to as being “directly on,” “directly connected to” or “directly coupled to” another element or layer, there are no intervening elements or layers present. As used herein, connected may refer to elements being physically and/or electrically connected to each other. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the invention.

Spatially relative terms, such as “below,” “lower,” “under,” “above,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” or “beneath” relative to other elements or features would then be oriented “above” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used in this specification, specify the presence of stated features, integers, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, a curved backlight assembly and a curved display device having the curved backlight assembly according to the invention will be explained in detail with reference to the accompanying drawings.

In this disclosure, the technical term “viewing angle” is defined as the angle present between the line of sight (“LOS”) of the viewer focusing on a particular surface region of the screen and the surface tangent plane at the intersection of the line of sight and the focused upon surface region. The difference between the central and the extreme left or right edge viewing angles is defined as and used to mean the “viewing angle difference” (VADmax).

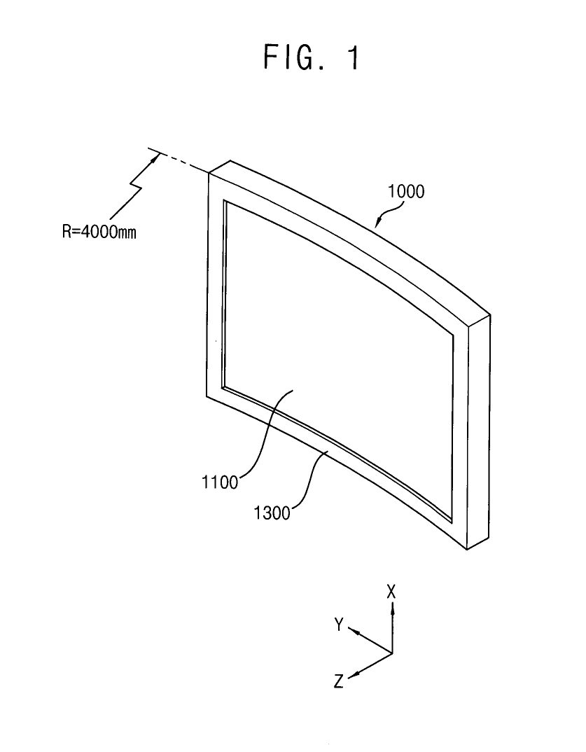

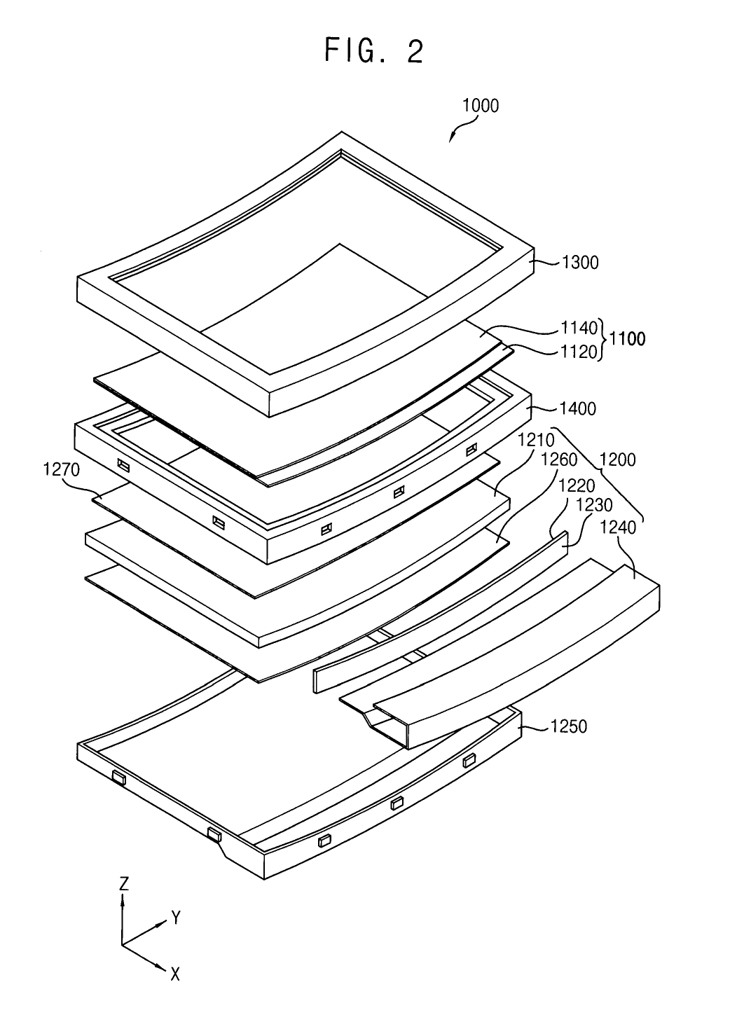

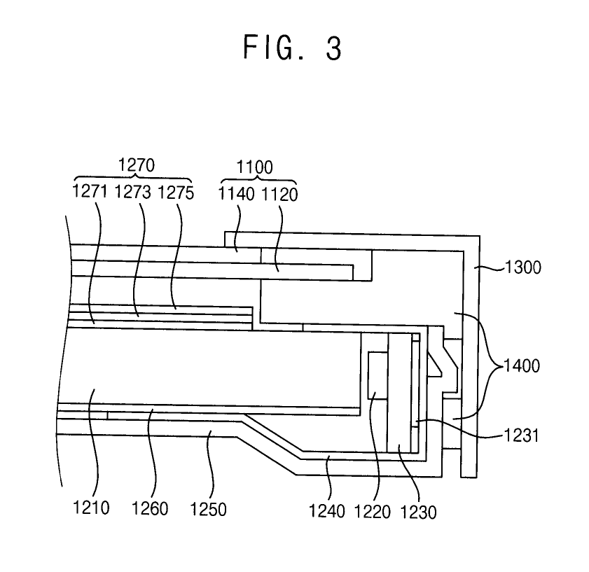

FIG. 1 is a perspective view schematically showing an exemplary embodiment of a curved display device 1000 according to the invention. FIG. 2 is an exploded perspective view schematically showing the curved display device 1000 shown in FIG. 1. FIG. 3 is a cross-sectional view of a portion of the curved display device 1000 shown in FIG. 2. Particularly, it is shown that a curved display device is curved along a long side thereof and includes a light emitting diode (“LED”) cover of a planar plate structure.

Referring to FIGS. 1, 2 and 3, a curved display device 1000 includes a display panel 1100, a curved backlight assembly 1200 and a top chassis 1300 which are each concavely bent to have a uniform curvature in X-Y plane. A curvature radius R corresponding to the curvature may be about 1,000 millimeters (mm) to about 4,000 mm (indicated as “R=4000 mm” in FIG. 1 as an example).

The display panel 1100 may have a curved shape having a uniform curvature in an X-Y plane. In an exemplary embodiment, the display panel 1100 may be a liquid crystal display (“LCD”) panel, a plasma display panel (“PDP”), an organic light-emitting display (“OLED”) panel, etc. In the exemplary embodiment, the display panel 1100 may include an LCD panel including an array substrate 1120, a color filter substrate 1140 facing the array substrate 1120, and a liquid crystal layer (not shown) interposed between the array substrate 1120 and the color filter substrate 1140. A size of the color filter substrate 1140 is substantially smaller than that of the array substrate 1120 in a top plan view. Thus, an area of the array substrate 1120 not covered by the color filter substrate 1140 is exposed. A pad part is disposed on an exposed area of the array substrate 1120.

In an exemplary embodiment of manufacturing the curved display device 1000, the display panel 1100 may be curved before the display panel 1100 is inserted into the top chassis 1300. In another exemplary embodiment of manufacturing the curved display device 1000, the display panel 1100 may be curved after the display panel 1100 is inserted into the top chassis 1300. In an exemplary embodiment of manufacturing the curved display device 1000, when the display panel 1100 is flexible, the display panel 1100 may be curved after the display panel 1100 is inserted into the top chassis 1300, for example. In an exemplary embodiment of manufacturing the curved display device 1000, when the display panel 1100 is rigid (e.g., not flexible), the display panel 1100 may be manufactured to have a curved shape of a predetermined curvature before the display panel 1100 is inserted into the top chassis 1300, for example.

The display panel 1100 may have a curved shape by various manufacturing methods. In an exemplary embodiment of manufacturing the curved display device 1000, a flat display panel is disposed between a first curved mold of a concave shape and a second curved mold of a convex shape facing the first curved mold, and then the curved shape display panel 1100 may be manufactured through a heat treatment and a pressing treatment. In manufacturing a curved shape display panel, a bottom surface of an array substrate of the flat display panel is disposed to contact the first curved mold.

The array substrate 1120 is a substrate on which thin-film transistors (“TFTs”) that are switching elements, are provided in a matrix shape. In the exemplary embodiment, the array substrate 1120 has a curved shape of uniform curvature. In an exemplary embodiment, the TFT has a source terminal connected to a data line, a gate terminal connected to a gate line and a drain terminal connected to a pixel electrode including a transparent conductive material.

The color filter substrate 1140 is disposed to face the array substrate 1120. The color filter substrate 1140 includes a red pixel, a green pixel and a blue pixel that are provided to realize colored light. In the illustrated exemplary embodiment, the color filter substrate 1140 has a curved shape of uniform curvature. A common electrode is disposed on the color filter substrate 1140, which is opposite to the pixel electrode of the array substrate 1120. The common electrode includes an optically transparent and electrically conductive material.

In an alternative exemplary embodiment, the display panel 1100 may include an array substrate on which color filters are provided and an opposite substrate on which a common electrode is provided to face the array substrate.

When a power is applied to a gate terminal of the TFT and the TFT is turned on, an electric field is generated between the pixel electrode and the common electrode. The electric field varies an aligning angle of the liquid crystal molecules of the liquid crystal layer interposed between the array substrate 1120 and the color filter substrate 1140. Thus, a light transmittance of the liquid crystal layer is varied in accordance with the variation of the aligning angle of the liquid crystal, so a desired image may be obtained.

The display panel 1100 may include a first polarization film (not shown) disposed below the array substrate 1120 and a second polarization film (not shown) disposed on (e.g., above) the color filter substrate 1140. The first polarization film includes a light transmitting axis of a first direction to polarize lights in a first direction. The second polarization film includes a light transmitting axis of a second direction to polarize lights in a second direction. In an exemplary embodiment, the light transmitting axis of the first polarization film may substantially perpendicular to the light transmitting axis of the second polarization film.

The curved backlight assembly 1200 is disposed at a rear surface of the display panel 1100 to provide light to the curved display panel 1100. In the illustrated exemplary embodiment, the curved backlight assembly 1200 may have a curved shape which is bent in accordance with a curvature of the display panel 1100. In the illustrated exemplary embodiment, a curvature radius of the curved backlight assembly 1200 may be about 1,000 mm to about 5,000 mm. In the illustrated exemplary embodiment, when the display panel 1100 has a curvature radius of about 1,000 mm to about 4,000 mm, the curved backlight assembly 1200 may have a curvature radius substantially greater than a curvature radius of the display panel 1100. In an exemplary embodiment, when the display panel 1100 has a curvature radius of about 3,000 mm, for example, the curved backlight assembly 1200 may have a curvature radius substantially greater than about 3,000 mm and substantially smaller than about 5,000 mm.

The curved backlight assembly 1200 includes a curved light guide panel (“LGP”) 1210, a point light source such as a LED 1220, a printed circuit board (“PCB”) 1230, a curved LED cover 1240 and a bottom chassis 1250.

The curved LGP 1210 includes a first side and a second side to be bent with respect to a central normal line of the first side. When the curved LGP 1210 has a rectangular shape, the first side may be a long side and the second side may be a short side, but the invention is not limited thereto.

In the exemplary embodiment, it is described that the curved LGP 1210 is bent with respect to a central normal line of the first side, but the invention is not be limited to this. In the illustrated exemplary embodiment, the curved LGP 1210 may be bent with respect to a central normal line corresponding to ⅓ position of the first side. Moreover, it is described that the curved LGP 1210 is symmetric with respect to the central normal line, but the curved LGP 1210 may be asymmetric with respect to the central normal line.

In the illustrated exemplary embodiment, the curved LGP 1210 may have a curved shape by various manufacturing methods. In an exemplary embodiment, a flat diffusion plate is disposed between a first curved mold of a concave shape and a second curved mold of a convex shape facing the first curved mold, and then the curved LGP 1210 may be manufactured through a heat treatment and a pressing treatment. In manufacturing a curved LGP, a bottom surface of the flat LGP is disposed to contact the first curved mold.

A plurality of LEDs 1220 generating lights are mounted on the PCB 1230. The PCB 1230 is disposed adjacent to the first side of the curved LGP 1210. The PCB 1230 is bent along the first side of the curved LGP 1210. Referring to FIG. 3, for example, the PCB 1230 and the LEDs 1220 mounted thereon, are disposed facing a curved light incident surface of the curved LGP 1210. The curved light incident surface may be extended along the first side of the curved LGP 1210, and the LEDs 1220 may be arranged along the extension direction of the first side of the curved LGP 1210.

The curved LED cover 1240 receives the PCB 1230. The curved LED cover 1240 is bent along the first side of the curved LGP 1210 to be coupled to a portion of the curved LGP 1210. In an exemplary embodiment, the curved LED cover 1240 is clipped to an upper portion (e.g., an upper surface or light exiting surface) of the curved LGP 1210 and a lower portion (e.g., a lower surface or opposite surface) of the curved LGP 1210. Side surfaces of the curved LGP 1210 may connect the light exiting and opposite surfaces to each other, and one of these side surfaces may be the light incident surface. An adhesive member 1231 such as a tape may be disposed between the PCB 1230 and the curved LED cover 1240.

In the exemplary embodiment, the curved LED cover 1240 may have a planar plate structure. That is, portions forming the curved LED cover 1240 may be substantially planar, and some of those portions may be bent to form the curved LED cover 1240 while other of those portions may not be bent.

The bottom chassis 1250 receives the curved LGP 1210, the PCB 1230 and the curved LED cover 1240 and is bent along a curvature of the curved LED cover 1240.

The curved backlight assembly 1200 may further include a reflection sheet 1260. The reflection sheet 1260 is disposed below the curved LGP 1210 to reflect lights emitted through a bottom surface of the curved LGP 1210 toward the curved LGP 1210.

The curved backlight assembly 1200 may further include optical sheets 1270. The optical sheets 1270 are disposed on the curved LGP 1210 to increase efficiency of lights incident from the curved LGP 1210. In an exemplary embodiment, the optical sheets 1270 may include a diffusion sheet 1271 diffusing lights incident from the curved LGP 1210 and prism sheets condensing the lights diffused by the diffusion sheet 1271. In an exemplary embodiment, the prism sheets may include a vertical prism sheet 1273 condensing lights in a vertical direction and a horizontal prism sheet 1275 condensing lights in a horizontal direction.

The top chassis 1300 secures the display panel 1100 and the curved backlight assembly 1200. The top chassis 1300 has an overall curved shape of a uniform curvature.

The curved backlight assembly 1200 may further include a middle mold 1400. The middle mold 1400 has a rectangular shape to receive the curved backlight assembly 1200 and support the display panel 1100.

As described above, according to the illustrated exemplary embodiment, a curved LED cover 1240 having a planar plate structure is coupled to a portion of a curved LGP 1210, both of which are bent so as to be adapted to a curved display panel 1100, so that a misalignment between the curved LGP 1210 and the LEDs 1220 may be removed. Therefore, a generation of a hot-spot phenomenon may be reduced or effectively prevented, so that the backlight assembly 1200 may emit uniform light to the display panel 1100.

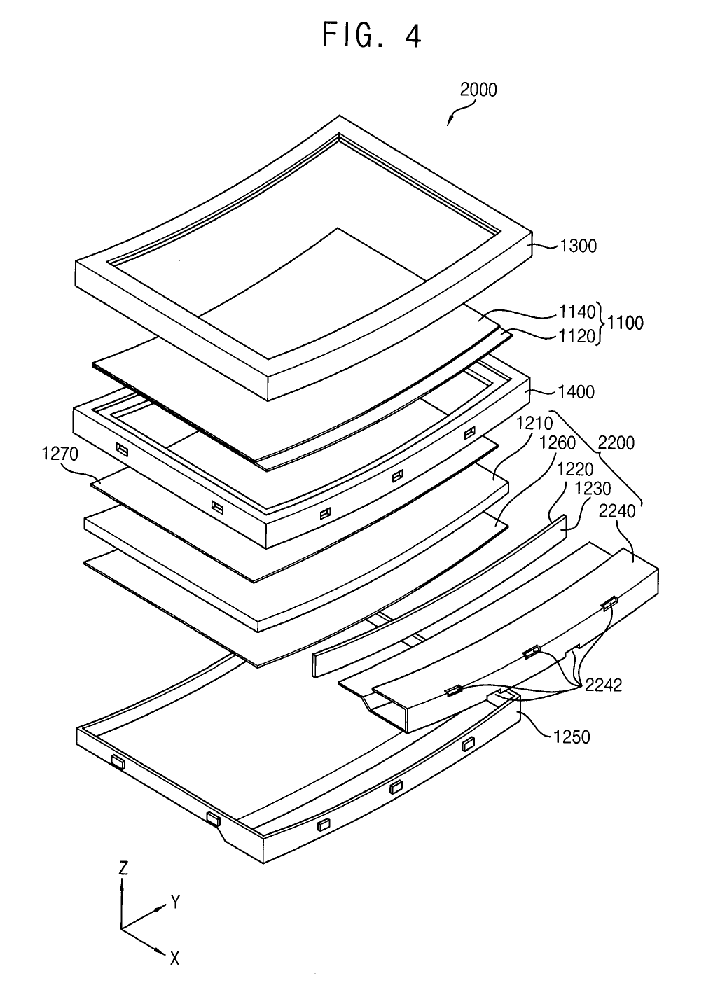

FIG. 4 is an exploded perspective view schematically showing another exemplary embodiment of a curved display device according to the invention. Particularly, it is shown that a curved display device is curved along a long side and includes an LED cover in which plural opening portions are defined therethrough.

Referring to FIG. 4, a curved display device 2000 includes a display panel 1100, a curved backlight assembly 2200 and a top chassis 1300 which are each concavely bent to have a uniform curvature in an X-Y plane. A curvature radius R corresponding to the curvature may be about 1,000 mm to about 4,000 mm.

The display panel 1100 and the top chassis 1300 are substantially the same as the display panel 1100 and the top chassis 1300 shown in FIG. 2, and thus any repetitive detailed description thereof will hereinafter be omitted.

The curved backlight assembly 2200 is disposed at a rear surface of the display panel 1100 to provide light to the curved display panel 1100. In the illustrated exemplary embodiment, the curved backlight assembly 2200 may have a curved shape which is bent in accordance with a curvature of the display panel 1100.

The curved backlight assembly 2200 includes a curved LGP 1210, a point light source such as a LED 1220, a PCB 1230, a curved LED cover 1240 and a bottom chassis 1250. The curved LGP 1210, the LEDs 1220, the PCB 1230 and the bottom chassis 1250 are substantially the same as the curved LGP 1210, the LEDs 1220, the PCB 1230 and the bottom chassis 1250 shown in FIG. 2, and any repetitive detailed description thereof will hereinafter be omitted.

The curved LED cover 2240 receives the PCB 1230. The curved LED cover 2240 is bent along the first side of the curved LGP 1210 to be coupled to a portion of the curved LGP 1210. In an exemplary embodiment, the curved LED cover 2240 is clipped to an upper portion of the curved LGP 1210 and a lower portion of the curved LGP 1210. An adhesive member (not shown) such as a tape may be disposed between the PCB 1230 and the curved LED cover 2240.

In the illustrated exemplary embodiment, plural opening portions 2242 are defined in the curved LED cover 2240. The opening portions 2242 may be defined at an area corresponding to a plurality of LEDs 1220. The opening portions 2242 may be arranged in a zigzag type in a Y-Z plane.

The bottom chassis 1250 receives the curved LGP 1210, the PCB 1230 and the curved LED cover 2240 and is bent along a curvature of the curved LED cover 2240.

The curved backlight assembly 2200 may further include a reflection sheet 1260 and optical sheets 1270. The reflection sheet 1260 and the optical sheets 1270 are substantially the same as the reflection sheet 1260 and the optical sheets 1270 shown in FIG. 2, and thus any repetitive detailed description thereof will hereinafter be omitted.

As described above, according to the illustrated exemplary embodiment, a curved LED 2240 cover in which plural opening portions are defined is coupled to a portion of a curved LGP 1210, both of which are bent so as to adapt to a curved display panel 1100, so that a misalignment between the curved LGP 1210 and the LEDs 1220 may be removed. Therefore, a generation of a hot-spot phenomenon may be reduced or effectively prevented, so that the backlight assembly 2200 may emit uniform light to the display panel 1100.

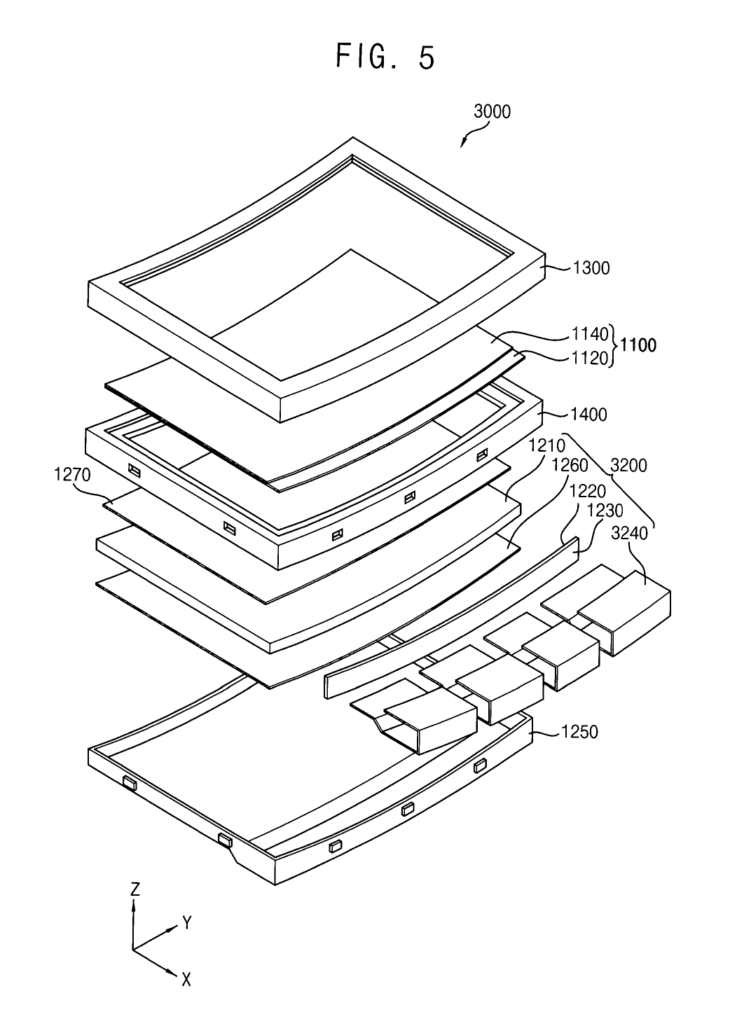

FIG. 5 is an exploded perspective view schematically showing still another exemplary embodiment of a curved display device according to the invention. Particularly, it is shown that a curved display device is curved along a long side and includes plural LED covers.

Referring to FIG. 5, a curved display device 3000 includes a display panel 1100, a curved backlight assembly 3200 and a top chassis 1300 which are each concavely bent to have a uniform curvature in an X-Y plane. A curvature radius R corresponding to the curvature may be about 1,000 mm to about 4,000 mm.

The display panel 1100 and the top chassis 1300 are substantially the same as the display panel 1100 and the top chassis 1300 shown in FIG. 2, and thus any repetitive detailed description thereof will hereinafter be omitted.

The curved backlight assembly 3200 is disposed at a rear surface of the display panel 1100 to provide light to the curved display panel 1100. In the illustrated exemplary embodiment, the curved backlight assembly 3200 may have a curved shape which is bent in accordance with a curvature of the display panel 1100.

The curved backlight assembly 3200 includes a curved LGP 1210, a point light source such as a LED 1220, a PCB 1230, plural curved LED covers 3240 and a bottom chassis 1250. The curved LGP 1210, the LEDs 1220, the PCB 1230 and the bottom chassis 1250 are substantially the same as the curved LGP 1210, the LEDs 1220, the PCB 1230 and the bottom chassis 1250 shown in FIG. 2, and thus any repetitive detailed description thereof will hereinafter be omitted.

The curved LED covers 3240 each receive the PCB 1230. Each curved LED cover 3240 is bent along the first side of the curved LGP 1210 to be coupled to a portion of the curved LGP 1210. In an exemplary embodiment, the curved LED covers 3240 are clipped to an upper portion of the curved LGP 1210 and a lower portion of the curved LGP 1210. An adhesive member (not shown) such as a tape may be disposed between the PCB 1230 and the curved LED covers 3240.

In the illustrated exemplary embodiment, the curved LED covers 3240 is spaced apart from each other along the first side of the curved LGP 1210 to be coupled to a respective portion of the curved LGP. Each of the curved LED covers 3240 may be disposed at an area corresponding to or covering an LED 1220 among the plurality of LEDs 1220. The LED covers 3240 and the LEDs 1220 may be in one-to-one correspondence, but the invention is note limited thereto.

The bottom chassis 1250 receives the curved LGP 1210, the PCB 1230 and the curved LED covers 3240 and is bent along a curvature of the plurality of LED covers 3240.

The curved backlight assembly 3200 may further include a reflection sheet 1260 and optical sheets 1270. The reflection sheet 1260 and the optical sheets 1270 are substantially the same as the reflection sheet 1260 and the optical sheets 1270 shown in FIG. 2, and thus any repetitive detailed description thereof will hereinafter be omitted.

As described above, according to the illustrated exemplary embodiment, plural curved LED covers 3240 are respectively coupled to a portion of a curved LGP 1210, both of which are bent so as to adapt to a curved display panel 1100, so that a misalignment between the curved LGP 1210 and the LEDs 1220 may be removed. Therefore, a generation of a hot-spot phenomenon may be reduced or effectively prevented, so that the backlight assembly 3200 may emit uniform light to the display panel 1100.

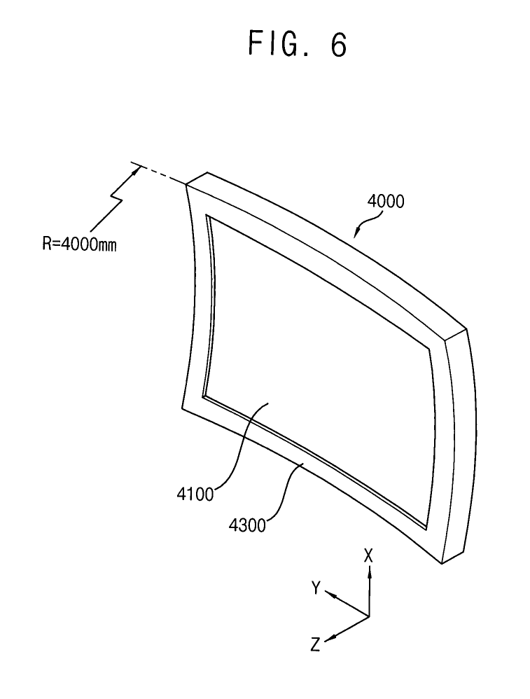

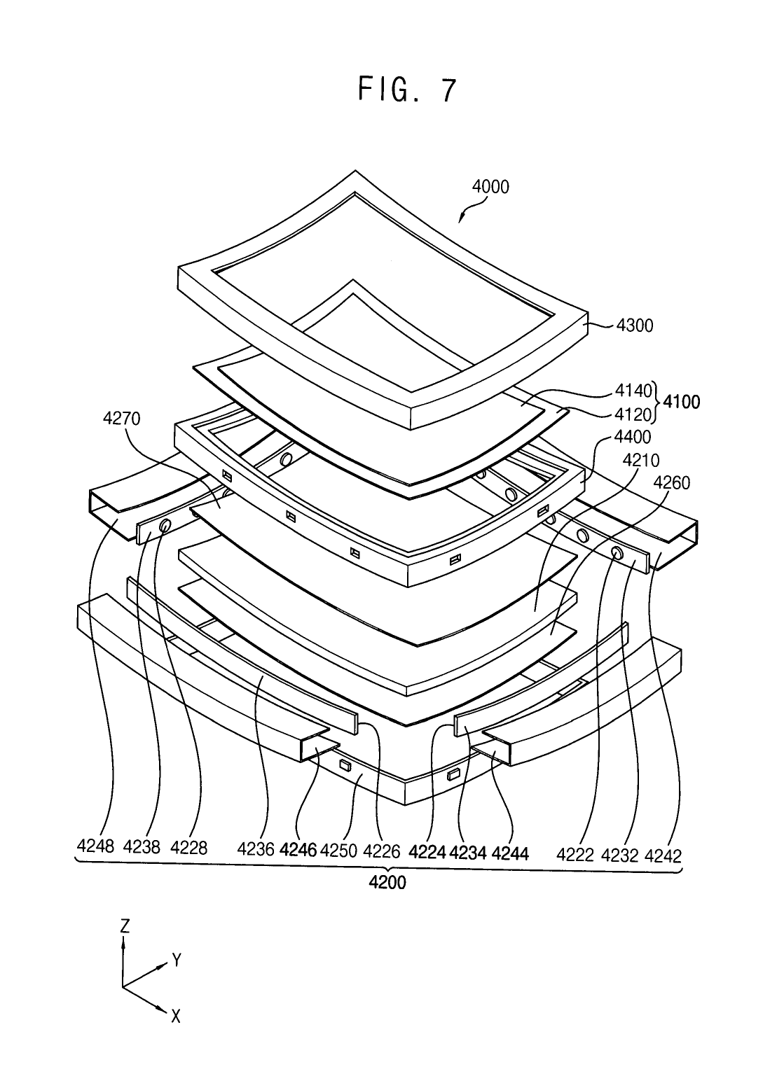

FIG. 6 is a perspective view schematically showing yet another exemplary embodiment of a curved display device according to the invention. FIG. 7 is an exploded perspective view schematically showing the curved display device shown in FIG. 6. Particularly, it is shown that a curved display device is curved along both a long side and a short side thereof, instead of being curved along only one side as illustrated in FIGS. 1-5.

Referring to FIGS. 6 and 7, a curved display device 4000 includes a display panel 4100, a curved backlight assembly 4200 and a top chassis 4300 which are each concavely bent to have a uniform curvature in an X-Y plane. A curvature radius R corresponding to the curvature may be about 1,000 mm to about 4,000 mm (indicated as “R=4000 mm” in FIG. 1 as an example).

The display panel 4100 may have a curved shape having a uniform curvature in an X-Y plane. In an exemplary embodiment, the display panel 4100 may be a LCD panel, a PDP, an OLED panel, etc. In the exemplary embodiment, the display panel 4100 may include an LCD panel including an array substrate 4120, a color filter substrate 4140 facing the array substrate 4120, and a liquid crystal layer (not shown) interposed between the array substrate 4120 and the color filter substrate 4140.

In an exemplary embodiment of manufacturing the curved display device 4000, the display panel 4100 may be curved before the display panel 4100 is inserted into the top chassis 4300. In another exemplary embodiment of manufacturing the curved display device 4000, the display panel 4100 may be curved after the display panel 4100 is inserted into the top chassis 4300. In an exemplary embodiment of manufacturing the curved display device 4000, when the display panel 4100 is flexible, the display panel 4100 may be curved after the display panel 4100 is inserted into the top chassis 4300, for example. In an exemplary embodiment of manufacturing the curved display device 4000, when the display panel 4100 is rigid (e.g., not flexible), the display panel 4100 may be manufactured to have a curved shape of a predetermined curvature before the display panel 4100 is inserted into the top chassis 4300, for example.

The display panel 4100 may have a curved shape by various manufacturing methods. In an exemplary embodiment of manufacturing the curved display device 4000, a flat display panel is disposed between a first curved mold of a concave shape and a second curved mold of a convex shape facing the first curved mold, and then the display panel 4100 may be manufactured through a heat treatment and a pressing treatment. In manufacturing a curved shape display panel, a bottom surface of an array substrate of the flat display panel is disposed to contact the first curved mold.

The array substrate 4120 is a substrate on which TFTs that are switching elements are provided in a matrix shape. In the exemplary embodiment, the array substrate 4120 has a curved shape of uniform curvature. In an exemplary embodiment, the TFT has a source terminal connected to a data line, a gate terminal connected to a gate line and a drain terminal connected to a pixel electrode including a transparent conductive material.

The color filter substrate 4140 is disposed to face the array substrate 4120. The color filter substrate 4140 includes a red pixel, a green pixel and a blue pixel that are provided to realize colored light. In the illustrated exemplary embodiment, the color filter substrate 4140 has a curved shape of uniform curvature. A common electrode is disposed on the color filter substrate 4140, which is opposite to the pixel electrode of the array substrate 4120. The common electrode includes an optically transparent and electrically conductive material.

In an alternative exemplary embodiment, the display panel 4100 may include an array substrate on which color filters are provided and an opposite substrate on which a common electrode is provided to face the array substrate.

When a power is applied to a gate terminal of the TFT and the TFT is turned on, an electric field is generated between the pixel electrode and the common electrode. The electric field varies an aligning angle of the liquid crystal molecules of the liquid crystal layer interposed between the array substrate 4120 and the color filter substrate 4140. Thus, a light transmittance of the liquid crystal layer is varied in accordance with the variation of the aligning angle of the liquid crystal, so a desired image may be obtained.

The display panel 4100 may include a first polarization film (not shown) disposed below the array substrate 4120 and a second polarization film (not shown) disposed on the color filter substrate 4140. The first polarization film includes a light transmitting axis of a first direction to polarize lights in a first direction. The second polarization film includes a light transmitting axis of a second direction to polarize lights in a second direction. In an exemplary embodiment, the light transmitting axis of the first polarization film may substantially perpendicular to the light transmitting axis of the second polarization film.

The curved backlight assembly 4200 is disposed at a rear surface of the display panel 4100 to provide light to the curved display panel 4100. In the illustrated exemplary embodiment, the curved backlight assembly 4200 may have a curved shape which is bent in accordance with a curvature of the display panel 4100.

The curved backlight assembly 4200 includes a curved LGP 4210, first LEDs 4222, second LEDs 4224, third LEDs 4226, fourth LEDs 4228, a first PCB 4232, a second PCB 4234, a third PCB 4236, a fourth PCB 4238, a first curved LED cover 4242, a second curved LED cover 4244, a third curved LED cover 4246, a fourth curved LED cover 4248 and a bottom chassis 4250.

The curved LGP 4210 includes a first side and a second side. The curved LGP 4210 may be bent with respect to both a central normal line of the first side and may be bent with respect to a central normal line of the second side. Hereinafter, it is described that a length of the first side is greater than a length of the second side. Alternatively, the length of the first side may be smaller than the length of the second side. Moreover, the length of the first side may be substantially equal to the length of the second side.

With reference to the perspective view of FIG. 6, the first LEDs 4222 are disposed on an upper side (X-direction) of the curved LGP 4210 in an XY-plane to provide the curved LGP 4120 with lights.

With reference to the perspective view of FIG. 6, the second LEDs 4224 are disposed on a right side (opposite to Y-direction) of the curved LGP 4210 in an XY-plane to provide the curved LGP 4120 with lights.

With reference to the perspective view of FIG. 6, the third LEDs 4226 are disposed on a lower side (opposite to X-direction) of the curved LGP 4210 in an XY-plane to provide the curved LGP 4120 with lights.

With reference to the perspective view of FIG. 6, the fourth LEDs 4228 are disposed on a left side (Y-direction) of the curved LGP 4210 in an XY-plane to provide the curved LGP 4120 with lights.

The first PCB 4232 having the first LEDs 4222 emitting lights mounted thereon, is adjacently disposed on the upper side of the curved LGP 4210. In the XY-plane, the first PCB 4232 is bent along the upper side of the curved LGP 4210.

The second PCB 4234 having the second LEDs 4224 emitting lights mounted thereon, is adjacently disposed on the right side of the curved LGP 4210. In the XY-plane, the second PCB 4234 is bent along the right side of the curved LGP 4210.

The third PCB 4236 having the third LEDs 4226 emitting lights mounted thereon, is adjacently disposed on the lower side of the curved LGP 4210. In the XY-plane, the third PCB 4236 is bent along a lower side of the curved LGP 4210.

The fourth PCB 4238 having the fourth LEDs 4228 emitting lights mounted thereon, is adjacently disposed on the left side of the curved LGP 4210. In the XY-plane, the fourth PCB 4238 is bent along the left side of the curved LGP 4210.

The first curved LED cover 4242 receives the first PCB 4232. The first curved LED cover 4242 is bent along the upper side of the curved LGP 4210 in the X-Y plane, so that the first curved LED cover 4242 is coupled to a portion of the curved LGP 4210. In the illustrated exemplary embodiment, in a Y-Z plane, the first curved LED cover 4242 is clipped to a portion of an upper surface (e.g., viewing side) of the curved LGP 4210 and a portion of a lower surface (e.g., opposite to the viewing side)_of the curved LGP 4210.

The second curved LED cover 4244 receives the second PCB 4234. The second curved LED cover 4244 is bent along the right side of the curved LGP 4210 in the X-Y plane, so that the second curved LED cover 4244 is coupled to a portion of the curved LGP 4210. In the illustrated exemplary embodiment, in the Y-Z plane, the second curved LED cover 4244 is clipped to a portion of the upper surface of the curved LGP 4210 and a portion of the lower surface of the curved LGP 4210.

The third curved LED cover 4246 receives the third PCB 4236. The third curved LED cover 4246 is bent along the lower side of the curved LGP 4210 in the X-Y plane, so that the third curved LED cover 4246 is coupled to a portion of the curved LGP 4210. In the illustrated exemplary embodiment, in the Y-Z plane, the third curved LED cover 4246 is clipped to a portion of the upper surface of the curved LGP 4210 and a portion of the lower surface of the curved LGP 4210.

The fourth curved LED cover 4248 receives the fourth PCB 4238. The fourth curved LED cover 4248 is bent along the left side of the curved LGP 4210 in the X-Y plane, so that the fourth curved LED cover 4248 is coupled to a portion of the curved LGP 4210. In the illustrated exemplary embodiment, in the Y-Z plane, the fourth curved LED cover 4248 is clipped to a portion of the upper surface of the curved LGP 4210 and a portion of the lower surface of the curved LGP 4210.

The bottom chassis 4250 receives the curved LGP 4210, the PCB 4230 and the curved LED covers and is respectively e bent along a curvature of the curved LED covers.

The curved backlight assembly 4200 may further include a reflection sheet 4260. The reflection sheet 4260 is disposed below the curved LGP 4210 to reflect lights emitted through a bottom surface of the curved LGP 4210 toward the curved LGP 4210.

The curved backlight assembly 4200 may further include optical sheets 4270. The optical sheets 4270 are disposed on the curved LGP 4210 to increase efficiency of lights incident from the curved LGP 4210. In an exemplary embodiment, the optical sheets 4270 may include a diffusion sheet diffusing lights incident from the curved LGP 4210 and prism sheets condensing the lights diffused by the diffusion sheet. In an exemplary embodiment, the prism sheets may include a vertical prism sheet condensing lights in a vertical direction and a horizontal prism sheet condensing lights in a horizontal direction.

The top chassis 4300 secures the display panel 4100 and the curved backlight assembly 4200. The top chassis 4300 has an overall curved shape of a uniform curvature.

The curved backlight assembly 4200 may further include a middle mold 4400. The middle mold 4400 has a rectangular shape to receive the curved backlight assembly 4200 and support the display panel 4100.

As described above, according to the illustrated exemplary embodiment, a plurality of curved LED covers is respectively coupled to four sides of a curved LGP 4210, each of which are bent so as to adapt to a curved display panel 4100, so that a misalignment between the curved LGP 4210 and the LEDs may be removed. Therefore, a generation of a hot-spot phenomenon may be reduced or effectively prevented, so that the backlight assembly 4200 may emit uniform light to the display panel 4100.

Having described exemplary embodiments of the invention, it is further noted that it is readily apparent to those of reasonable skill in the art that various modifications may be made without departing from the spirit and scope of the invention which is defined by the metes and bounds of the appended claims.

What is claimed is:

1. A curved backlight assembly comprising:
a curved light guide plate comprising a first side and a second side;
a light source which generates light;
a printed circuit board on which the light source is mounted and which is adjacent to the first side of the curved light guide plate; and
a curved light source cover which receives the printed circuit board and is curved along the first side of the curved light guide plate.

2. The curved backlight assembly of claim 1, wherein the curved light source cover is coupled to a portion of the curved light guide plate.

3. The curved backlight assembly of claim 2, wherein the curved light source cover comprises a plurality of substantially planar plates.

4. The curved backlight assembly of claim 2, wherein an opening portion is defined in the curved light source cover.

5. The curved backlight assembly of claim 4, wherein the opening portion is defined at an area corresponding to the light source.

6. The curved backlight assembly of claim 4, further comprising a plurality of light sources and a plurality of opening portions,
wherein the plurality of opening portions is arranged in a zigzag type.

7. The curved backlight assembly of claim 1, further comprising a plurality of curved light source covers which is spaced apart from each other, and each coupled to a portion of the curved light guide plate.

8. The curved backlight assembly of claim 7, further comprising a plurality of light sources,
wherein the curved light source covers respectively cover the plurality of light sources.

9. The curved backlight assembly of claim 1, wherein the printed circuit board is curved along the first side of the curved light guide plate.

10. The curved backlight assembly of claim 1, wherein a length of the first side of the curved light guide plate and a length of the second side of the light guide plate are different from each other.

11. The curved backlight assembly of claim 1, further comprising a bottom chassis which receives the curved light guide plate, the printed circuit board and the curved light source cover,
wherein the bottom chassis is curved along a curvature of the curved light source cover.

12. A curved display device comprising:
a display panel assembly comprising a display panel which display an image; and
a curved backlight assembly which is on a rear surface of the display panel assembly and provides the display panel with light,
the curved backlight assembly comprising:
a curved light guide plate comprising a first side and a second side;
a light source which generates the light;
a printed circuit board on which the light source is mounted and which is adjacent to the first side of the curved light guide plate; and
a curved light source cover which receives the printed circuit board and is curved along the first side of the curved light guide plate.

13. The curved display device of claim 12, wherein
the curved light source cover is coupled to a portion of the curved light guide plate, and
the curved light source cover comprises a plurality of substantially planar plates.

14. The curved display device of claim 12, wherein
the curved light source cover is coupled to a portion of the curved light guide plate, and
an opening portion is defined in the curved light source cover.

15. The curved display device of claim 12, further comprising a plurality of light source covers which is coupled to a portion of the curved light guide plate and spaced apart from each other along the curved light guide plate.

16. The curved backlight assembly of claim 1, wherein the light source is a light-emitting diode.

17. The curved backlight assembly of claim 12, wherein the light source is a light-emitting diode.

18. The curved backlight assembly of claim 1, further comprising a plurality of light sources,
wherein the light sources mounted on the printed circuit board and received in the curved light source cover are arranged along a curved light incident surface of the curved light guide plate at the first side of the curved light guide plate.
